(19) United States
(12) Patent Application Publication
(10) Pub. No.: US 2026/0071886 A1
(43) Pub. Date: Mar. 12, 2026

(54) SYSTEM AND METHOD FOR UNIFIED MAP ALIGNMENT AND COORDINATE TRANSFORMATION ACROSS MULTIPLE DATA FORMATS

(71) Applicant: VERIZON PATENT AND LICENSING INC., Basking Ridge, NJ (US)

(72) Inventors: Aamir HUSAIN, Jersey City, NJ (US); Sean HSU, Long Island City, NY (US); Adrian C. GONZALEZ, San Jose, CA (US)

(73) Assignee: VERIZON PATENT AND LICENSING INC., Basking Ridge, NJ (US)

(21) Appl. No.: 18/830,687

(22) Filed: Sep. 11, 2024

(51) Int. Cl. G01C 21/00; G06T 7/33

(52) U.S. Cl. CPC G01C 21/3804; G01C 21/3867; G06T 7/33

(57) ABSTRACT

This disclosure presents a system and method for aligning diverse map types and transforming coordinates between them. The method involves receiving a map, selecting an alignment map, and choosing an alignment method. The system then performs the alignment process, generating a transformation matrix that defines the spatial relationship between the maps. The alignment quality is evaluated, and if satisfactory, the transformation matrix is integrated into a transformation tree data structure. This tree represents spatial relationships between multiple maps, enabling complex coordinate transformations. The method supports various map types, including floor plans, satellite imagery, and geographic data, allowing for their integration into a unified spatial framework. By addressing the challenges of aligning maps from different sources and formats, this system facilitates accurate positioning, navigation, and spatial analysis across heterogeneous map environments.

### BACKGROUND

In modern industrial and commercial environments, location-based services and applications have become increasingly prevalent. These services often rely on various mapping technologies to represent physical spaces and track the positions of assets or individuals within those spaces. As the complexity of these environments grows, so does the need for sophisticated mapping solutions that can integrate data from multiple sources and coordinate systems. Traditional mapping systems have typically focused on specific data formats or use cases, limiting their flexibility and scalability in diverse settings.

### BRIEF DESCRIPTION OF THE DRAWINGS

FIG. 1 is a block diagram illustrating a system for unified map alignment and coordinate transformation across multiple data formats according to some of the example embodiments.

FIG. 2 is a schematic diagram showing the organization of maps into map groups within a transformation tree structure according to some of the example embodiments.

FIG. 3 is a flow diagram illustrating a method for aligning non-geographic maps according to some of the example embodiments.

FIG. 4 is a flow diagram illustrating a method for aligning geographic maps according to some of the example embodiments.

FIG. 5 is a flow diagram illustrating a method for automatic map alignment according to some of the example embodiments.

FIG. 6 is a flow diagram illustrating a method for manual map alignment using calibration points according to some of the example embodiments.

FIG. 7 is a flow diagram illustrating a method for manual alignment of geographic maps using warp factors according to some of the example embodiments.

FIG. 8 is a flow diagram illustrating a method for transforming GPS coordinates to a Cartesian coordinate system according to some of the example embodiments.

FIG. 9 is a block diagram of a computing device according to some embodiments of the disclosure.

### DETAILED DESCRIPTION

In modern location-based applications and services, a technical challenge arises when integrating and representing positional information from multiple sources and reference frames. This challenge stems from the diversity of map formats, coordinate systems, and data representations used across different devices, sensors, and mapping technologies. Traditional mapping systems often cannot provide a unified approach for accurately translating and aligning spatial data between these varied formats and reference frames.

The foregoing technical problem is further compounded by the complexity of converting between geographic coordinate systems (such as latitude and longitude) and local Cartesian coordinate systems often used in indoor mapping or robotics applications. The lack of a standardized approach for performing these conversions while maintaining spatial accuracy across different map scales and orientations presents a significant barrier to creating cohesive, multi-layered spatial representations.

The present disclosure addresses these technical challenges by providing a unified system and method for map alignment and coordinate transformation across multiple data formats. At its core, the solution utilizes map groups organized within a comprehensive transformation tree. This structure allows for the integration of diverse digital map types, including (without limitation) Portable Document Format (PDF) floor plans, bitmap images, Joint Photographic Experts Group (JPEG) maps, and geocoded references, into a single, coherent spatial framework.

In some implementations, the system employs automatic alignment algorithms to establish precise transformations between different map representations. These algorithms handle the task of feature matching across disparate map formats, as well as the calculation of scale factors, rotations, and translations for accurate spatial alignment. The system may incorporate methods for converting between geographic and Cartesian coordinate systems, ensuring that location data from various sources can be accurately represented and transformed within the unified spatial model. By addressing these technical problems, the system enables the creation of more robust and versatile location-based applications capable of seamlessly integrating spatial data from a wide array of sources and formats.

The unified map alignment and coordinate transformation system described herein enables a wide range of applications across various industries. In some implementations, the system can be used in indoor navigation scenarios, allowing for transitioning between outdoor Global Positioning System (GPS)-based positioning and indoor positioning using local coordinate systems.

In some implementations, the system can be applied to facility management systems. For example, the system can integrate various types of maps, from broad campus layouts to detailed equipment diagrams, allowing for asset tracking and space utilization analysis. The system may process different map types and coordinate systems to create a unified spatial representation of a facility.

In some implementations, the system can similarly be used for urban planning applications. For example, the system can align historical maps with modern satellite imagery, enabling temporal analysis of urban development. The system may process maps from different time periods, aligning them based on common features or landmarks to facilitate comparison and analysis. Such a system can then be used to animate or otherwise illustrate changes in landscape over time in a manner not possible with existing tools.

In some implementations, the system can be applied to logistics and supply chain management. For example, the system can integrate diverse map types, from global shipping routes to detailed warehouse floor plans. This integration allows for tracking and coordination of assets across different scales and environments. In one example, a package can be tracked from its global GPS coordinates during shipping, through the local coordinate system of a distribution center, and finally to its precise location on a delivery truck, all within a single, cohesive spatial framework.

In some implementations, the system can be used for emergency response and disaster management. For example, the system can align various map types, from regional maps to detailed building floor plans, allowing emergency services to coordinate responses across different scales and environments. In a large-scale disaster scenario, the system may enable responders to seamlessly transition from using satellite imagery for overall situation assessment to detailed indoor maps for building-specific operations, while maintaining accurate positioning and coordination between different teams and assets.

These capabilities make the system valuable in fields ranging from logistics and emergency response to augmented reality gaming and location-based services. The system's ability to handle different map scales and types allows for the incorporation of various data layers, such as zoning information, utilities infrastructure, and demographic data, providing a comprehensive tool for spatial analysis and decision-making across multiple domains.

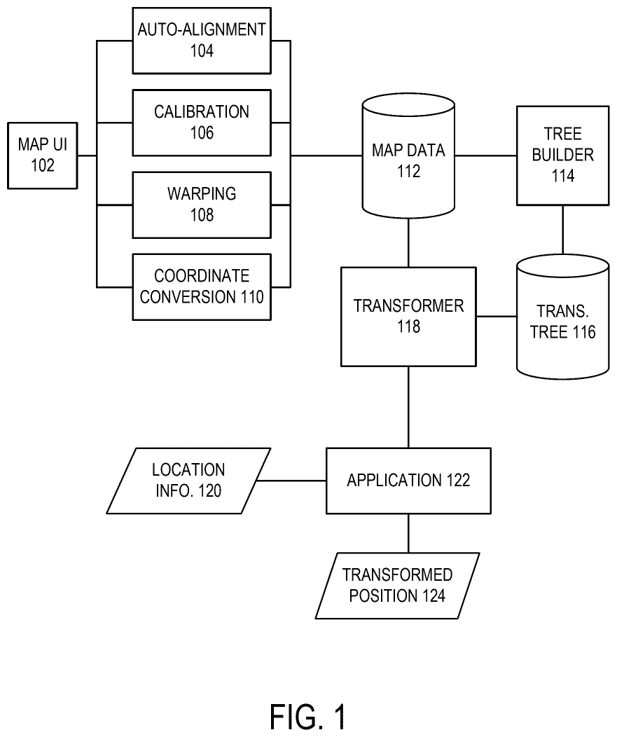

FIG. 1 is a block diagram illustrating a system for unified map alignment and coordinate transformation across multiple data formats.

In some implementations, the system includes a map UI 102 which serves as the primary interface for user interactions. The map UI 102 enables users to upload maps, create map groups, align maps, and visualize relationships between different map representations. The map UI 102 can provide a graphical interface that allows users to interact with various mapping functionalities. In some implementations, map UI 102 enables a “human-in-the-loop” process, allowing alignment and transformation processes to be verified and adjusted by human operators when desired. The map UI 102 may communicate with core components that perform specific functions within the system, passing user inputs and receiving processed data for display, as described herein.

In some implementations, the system includes an auto-alignment component 104 that automatically detects and matches features between different maps. Auto-alignment component 104 can utilize computer vision techniques to identify corresponding points between two maps. In one implementation, auto-alignment component 104 can use an ORB (Oriented FAST and Rotated BRIEF) detector for feature matching. In some implementations, an ORB detector may be used due to its speed and rotation invariance, making it suitable for aligning maps with different orientations or scales. Auto-alignment component 104 can process input maps to detect key features, match these features across maps, and calculate initial transformation parameters. The results of this automatic alignment may then be passed back to map UI 102 for user verification or further refinement.

In some implementations, the system includes a calibration component 106 that handles manual alignment processes. Calibration component 106 may allow users to define corresponding points between two maps when automatic alignment is not feasible or when greater precision is required. Calibration component 106 can process user-defined calibration points to calculate transformations. It may receive input from map UI 102 in the form of user-selected points on both source and target maps. Using these points, calibration component 106 can compute a transformation matrix that aligns the maps.

In some implementations, the system includes a warping component 108 responsible for handling the alignment of geographic maps. Warping component 108 may apply scale, rotation, and translation transformations to align maps based on geographic coordinates and user-defined anchor points. In some implementations, warping component 108 works in conjunction with calibration component 106 but specializes in dealing with geographic data. Warping component 108 can take into account the curvature of the Earth when dealing with large-scale maps and apply appropriate projections to ensure accurate alignment. It may calculate warp factors (scale, rotation, translation) to transform one geographic map to align with another.

In some implementations, the system includes a coordinate conversion component 110 that performs transformations between different coordinate systems. For example, coordinate conversion component 110 may convert latitude and longitude coordinates to local Cartesian coordinates. Coordinate conversion component 110 can implement mathematical formulas for coordinate system conversions, including calculations required for transforming between geographic (latitude/longitude) and projected coordinate systems. In some implementations, coordinate conversion component 110 integrates data from GPS devices with local coordinate systems used in indoor mapping or robotics applications.

In some implementations, the system incorporates data from map data store 112, which includes various types of map information. Map data store 112 may include floor plans, satellite imagery, and geographic reference data. This data can serve as input for alignment and transformation processes. In some implementations, map data store 112 can store data in various formats, including vector data (e.g., PDF, SVG), raster images (e.g., JPEG, PNG), and structured geographic data (e.g., GeoJSON, Shapefiles). The system may be configured to handle this diversity of data formats, enabling integration of maps from multiple sources.

In some implementations, the system includes a tree builder component 114 that constructs and maintains one or more transformation trees stored in a transformation tree data store 116. A transformation tree may represent relationships and transformations between different maps and coordinate systems within the system. In some implementations, each node in transformation tree can represent a map or coordinate frame, and each edge represents a transformation between two frames. Tree builder component 114 can update this structure as new maps are added, or alignments are refined. It may determine efficient paths for transforming coordinates between any two frames in the tree. The transformation tree can store the hierarchical relationships between different maps and coordinate frames. Each transformation in the tree can be represented by a matrix that encapsulates the scale, rotation, and translation required to convert coordinates from one frame to another. The tree structure allows for composition of multiple transformations when converting between distantly related coordinate frames.

In some implementations, the system includes a transformer component 118 that can read a transformation tree from tree builder component 114 and convert location information 120 between different coordinate frames. In some implementations, location information 120 represents the input data for coordinate transformations. This can include points of interest, device locations, or any other spatial data that needs to be represented across multiple maps or coordinate systems. The location information 120 can come from various sources, such as GPS devices, indoor positioning systems, or manually input coordinates via application 122.

In some implementations, transformer component 118 applies the appropriate series of transformations to accurately represent location data across various maps and coordinate systems. When given a source coordinate frame, a target coordinate frame, and a point to transform, transformer component 118 traverses a corresponding transformation tree to find the optimal path between the frames. It then applies each transformation along this path sequentially to convert the point from the source frame to the target frame.

As illustrated, the output of the system can comprise a transformed position 124, which represents the result of the coordinate transformation process. This transformed position accurately represents the location information 120 in the desired target coordinate frame or map. The transformed position 124 can be used by other systems or displayed to the user through the map UI 102, enabling accurate positioning and spatial analysis across diverse map sources and coordinate systems.

Various details of the above system are described in connection with the following flow diagrams.

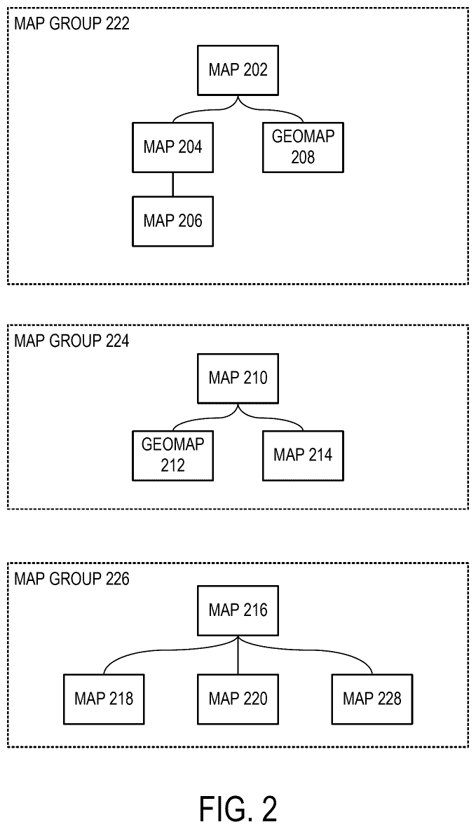

FIG. 2 is a schematic diagram showing the organization of maps into map groups within a transformation tree structure.

In some implementations, the system organizes maps into distinct map groups. For example, FIG. 2 depicts three map groups: map group 222, map group 224, and map group 226. Each map group may represent a collection of related maps that typically correspond to the same physical space or area of interest.

In some implementations, map groups can have complex hierarchies. For example, map group 222 shows map 202 as the root, with map 204 and geomap 208 directly connected to it, and map 206 connected to map 204, forming a chain of transformations. This structure may imply that transforming coordinates from map 206 to map 202 requires applying two successive transformations: first from map 206 to map 204, then from map 204 to map 202. In some implementations, a map group includes a geographic reference map (referred to as a “geomap”). For example, geomap 208 is connected to map 202 in map group 222, allowing for the integration of geographic coordinates with the local coordinate systems of the other maps in the group.

In some implementations, map groups can have different structures or combinations of map types. For example, map group 224 contains map 210 as its root, with geomap 212 and map 214 directly connected to it. This configuration may suggest that both geomap 212 and map 214 have been aligned or transformed relative to map 210. The inclusion of geomap 212 in this group may enable geographic referencing for the entire group.

In some implementations, a map group can include several child maps. For example, map group 226 includes map 216 serving as the root of the group, with maps 218, 220, and 228 directly connected to it. This arrangement may indicate that maps 218, 220 and 228 have been aligned or transformed relative to map 216.

In some implementations, connections between maps within each group represent transformation relationships. These transformations may enable the system to convert coordinates or align features between connected maps. The hierarchical structure can allow for computation of transformations between any two maps within a group by composing the transformations along the path that connects them.

The organization of maps into groups may serve several purposes. It can allow for logical separation of maps belonging to different physical spaces or projects. It may also enable processing by limiting the scope of potential transformations to within a group. Furthermore, this structure can support scalability, as new maps may be easily added to existing groups or new groups can be created for distinct areas or projects. In some implementations, the transformation tree structure enables the system to handle diverse map types and coordinate systems in a unified manner. It may provide a flexible and extensible framework for managing spatial relationships between multiple maps, regardless of their original format or coordinate system.

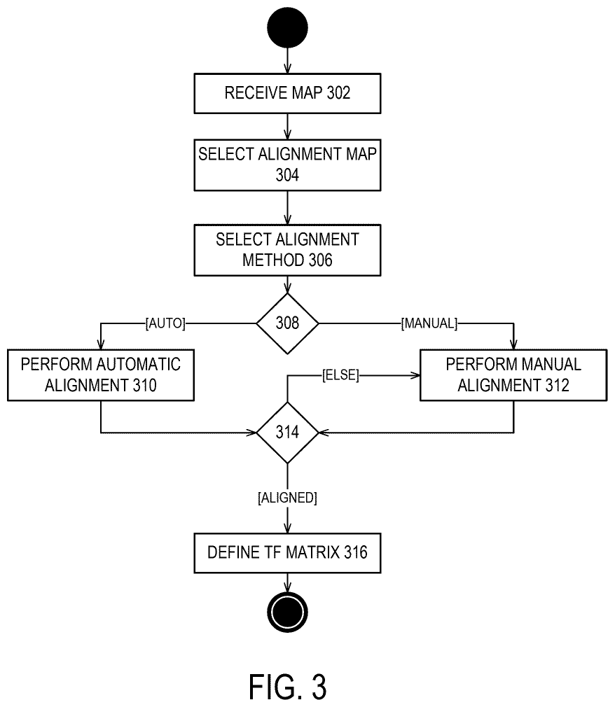

FIG. 3 is a flow diagram illustrating a method for aligning non-geographic maps according to some of the example embodiments.

In step 302, the method can include receiving a map. In some implementations, this step can include accepting input of a new map that needs to be aligned with existing maps in the system via, for example, a user interface such as map UI 102. The map may be in various formats, such as PDF, bitmap, or JPEG. In some implementations, the method performs initial processing on the received map, such as converting it to a standardized internal format or extracting metadata like resolution and scale information.

In step 304, the method can include selecting an alignment map. In some implementations, this step can include choosing an existing map within the system to which the newly received map will be aligned. The alignment map may serve as a reference for the transformation process. In some implementations, the selection is done automatically by the method based on certain criteria (e.g., spatial proximity, similarity in features). In other implementations, the selection is done manually by a user through a map UI such as that described in FIG. 1.

In step 306, the method can include selecting an alignment method. In some implementations, the method provides multiple methods for map alignment including, without limitation, an automatic and manual method. The automatic method may utilize computer vision techniques to detect and match features between the maps, while the manual method may rely on user-defined calibration points. Details of these methods are described in the following figures and are not repeated herein.

In step 308, the method can determine which alignment method was selected. If the automatic method was chosen, the method moves to step 310. If the manual method was selected, the method proceeds to step 312. In some implementations (not illustrated), if neither method was selected or an error occurred, the method may return to step 306 for re-selection.

In step 310, the method can perform automatic alignment. As will be discussed in more detail, the method may apply feature detection algorithms, such as the ORB detector, to identify corresponding points between the new map and the alignment map. These detected features can then be used to calculate an initial transformation matrix that aligns the two maps.

In step 312, the method can perform manual alignment. As will be discussed in more detail, a user may be prompted to select corresponding points on both the new map and the alignment map through the map UI. These user-defined calibration points can then be used to compute the transformation matrix.

In step 314, the method can check if the alignment is satisfactory. In some implementations, this step may involve visual inspection by the user through the map UI, where the aligned maps are overlaid for comparison. In other implementations, the method may perform automated checks, such as calculating the mean squared error between matched features or evaluating the consistency of the transformation with previously established relationships in the map group.

If the alignment is not satisfactory, the method can return to step 306 to select a different alignment method or to refine the current alignment. This loop may allow for iterative refinement of the alignment, combining automatic and manual methods as needed to achieve the desired accuracy.

If the alignment is satisfactory, the method can move to step 316.

In step 316, the method can include defining the transformation matrix. In some implementations, this step finalizes the calculated transformation matrix and integrates it into a corresponding transformation tree for a given map group. The transformation matrix may include parameters for translation, rotation, and scaling, allowing for conversion of coordinates between the new map and the alignment map.

In some implementations, the transformation matrix can be stored in one or both of meter-based and pixel-based formats. The meter-based matrix may allow for accurate real-world measurements and positioning, while the pixel-based matrix may be used for rendering and display purposes in the map UI.

After the transformation matrix is defined, the method can update its internal data structures. In some implementations, this includes adding the new map to the appropriate map group within the transformation tree, as illustrated in FIG. 2. The method may also update any dependent transformations that may be affected by the addition of this new map.

The method described in FIG. 3 may enable the method to handle a wide variety of non-geographic maps, integrating them into a unified spatial framework. By providing both automatic and manual alignment options, the method can offer flexibility to handle different scenarios, from maps with clear, matchable features to those requiring expert human input for accurate alignment. In some implementations, this alignment process forms a part of building and maintaining the comprehensive transformation tree, which enables the method to perform coordinate transformations between any pair of maps within the tree. The iterative nature of the alignment process, with the option to refine and verify alignments, may ensure high accuracy in the resulting spatial relationships between maps.

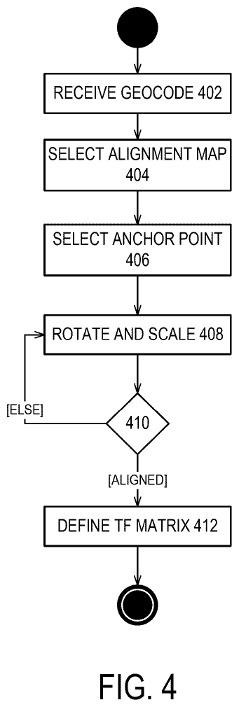

FIG. 4 is a flow diagram illustrating a method for aligning geographic maps according to some of the example embodiments.

In step 402, the method can include receiving a geocode. In some implementations, this step involves the method accepting geographic coordinate information, typically in the form of latitude and longitude. The geocode may be obtained through various means, such as user input, address lookup services, or GPS data from mobile devices. In some implementations, the method performs initial validation on the received geocode to ensure it falls within expected ranges and formats.

In step 404, the method can include selecting an alignment map. In some implementations, this step involves choosing an existing map within the system to which the geographic information will be aligned. The alignment map may be a non-geographic map, such as a floor plan or site layout, that represents the area of interest. In some implementations, the selection is done automatically by the method based on the proximity of the geocode to known geographic references of existing maps. In other implementations, the selection is done manually by a user through the map UI described in FIG. 1.

In step 406, the method can include selecting an anchor point. In some implementations, this step is used for establishing the relationship between the geographic coordinate system and the local coordinate system of the alignment map. In some implementations, the user may be prompted to identify a specific point on the alignment map that corresponds to a known geographic location. This anchor point can serve as the basis for calculating the transformation between the two coordinate systems.

In step 408, the method can perform rotation and scaling operations. In some implementations, this step allows for the adjustment of the alignment map's orientation and scale to match the geographic reality represented by the geocode. The method may provide interactive tools through the map UI for the user to rotate the alignment map and adjust its scale. These operations may be implemented as non-geographic maps often can have arbitrary orientations and scales that do not directly correspond to real-world geographic measurements.

In some implementations, during the rotation process, the user can specify the angle by which the alignment map should be rotated to align with true north (or other reference direction). This rotation may ensure that the cardinal directions on the alignment map correspond correctly to real-world directions.

In some implementations, the scaling process involves adjusting the size of the alignment map to accurately represent real-world distances. This can be done by specifying a known distance between two points on the alignment map and correlating it with the corresponding geographic distance. The method may provide interactive tools through the map user interface for the user to perform rotation and scaling operations. These tools can include sliders for adjusting rotation angle and scale factor, as well as direct manipulation controls on the map itself. In some implementations, users can drag corners or edges of the map to scale it or use a rotation handle to align it with known geographic features. The method may provide real-time visual feedback, overlaying the adjusted map on a geographic reference to help users achieve precise alignment.

In step 410, the method can check if the alignment is satisfactory. In some implementations, this step involves visual inspection by the user through the map UI, where the alignment map is overlaid on a geographic map or satellite imagery for comparison. The method can also provide tools for quantitative assessment, such as displaying the calculated scale factor and rotation angle for user verification.

If the alignment is not satisfactory, the method can return to step 406 to reselect the anchor point or to step 408 to further adjust the rotation and scaling. This loop may allow for iterative refinement of the alignment, enabling the user to fine-tune the transformation until the desired accuracy is achieved.

If the alignment is satisfactory, the method can move to step 412.

In step 412, the method can define the transformation matrix. In some implementations, this step finalizes the calculated transformation parameters and integrates them into the system's transformation tree. The transformation matrix for geographic alignment may typically include parameters for translation (based on the anchor point), rotation, and scaling.

In some implementations, the method stores the transformation matrix in a format that allows for conversion between geographic coordinates (latitude and longitude) and the local coordinate system of the alignment map. This may involve storing additional metadata such as the reference ellipsoid used for geographic calculations and any projection information.

After the transformation matrix is defined, the method can update internal data structures. In some implementations, this includes adding the new geographic reference to the appropriate map group within the transformation tree, as illustrated in FIG. 2. The method may also update any dependent transformations that may be affected by this new geographic alignment.

The method described in FIG. 4 may enable the system to integrate geographic information with non-geographic maps, creating a bridge between different spatial reference systems. This capability can be useful for applications that need to correlate real-world geographic locations with detailed local maps, such as indoor navigation systems or facility management tools. In some implementations, by providing interactive tools for rotation and scaling, the method allows for precise alignment even when dealing with maps that may have been created without strict geographic references. The iterative nature of the alignment process may ensure that users can achieve high accuracy in relating local map coordinates to real-world geographic positions.

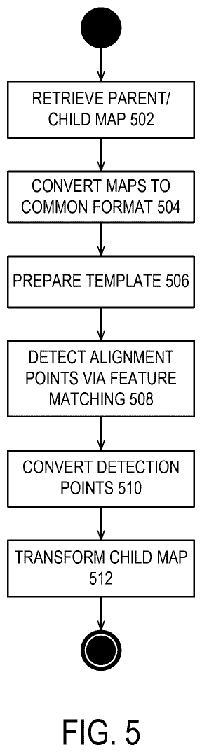

FIG. 5 is a flow diagram illustrating a method for automatic map alignment according to some of the example embodiments.

In step 502, the method can include retrieving parent and child maps.

In some implementations, the parent map serves as the reference to which the child map will be aligned. In some implementations, the method can perform initial checks to ensure both maps are compatible with the automatic alignment process, such as verifying image quality and resolution. In some implementations, this step involves accessing metadata associated with each map, including information about their original formats, scales, and any pre-existing transformation data.

In step 504, the method can include converting the maps to a common format.

In some implementations, this step is implemented to ensure that subsequent image processing operations can be applied consistently. In some implementations, the method may convert both maps to a standardized internal format, such as a multi-dimensional array. This conversion process can involve color space transformations, such as converting color images to grayscale, to facilitate feature detection. In some implementations, the standardization process also includes normalizing the pixel values and adjusting the contrast to enhance feature visibility. By converting both maps to a common format, the method can ensure that the feature detection algorithms operate efficiently and produce comparable results across different map types.

In step 506, the method can prepare a template for feature detection.

In some implementations, this step can include preprocessing the child map to optimize it for alignment with the parent map. The method can perform operations such as resizing the child map to match the dimensions of the parent map and applying border padding to accommodate potential translations. In some implementations, the resizing operation can use interpolation techniques to maintain image quality while adjusting the dimensions. For example, border padding may be applied symmetrically to allow for translations in any direction during the alignment process. Alternatively, or in conjunction with the foregoing, the method can also apply image enhancement techniques such as histogram equalization or adaptive thresholding to improve the contrast of key features. In some implementations, this step can create a standardized representation of the child map that maximizes the likelihood of successful feature matching with the parent map.

In step 508, the method can include detecting alignment points via feature matching.

In some implementations, this step utilizes computer vision algorithms to identify corresponding points between the parent and child maps. The method may implement feature detection and description algorithms, such as the ORB (Oriented FAST and Rotated BRIEF) detector, although other similar algorithms may be used.

In various implementations, the feature detection process can begin by identifying keypoints in both the parent and child maps. These keypoints may be distinctive features such as corners, edges, or high-contrast regions. For each keypoint, the method may compute a descriptor, which is a numerical representation of the local image patch around the keypoint. In some implementations, the method can then match these descriptors between the parent and child maps to find corresponding features. In some implementations, to improve the robustness of feature matching, the method may employ techniques such as ratio tests to filter out ambiguous matches and RANSAC (Random Sample Consensus) to remove outliers.

In step 510, the method can include converting the detected points from pixel coordinates to real-world units.

In some implementations, this conversion is performed to ensure that the subsequent transformation calculations result in a matrix that can be applied to real-world coordinates. The conversion process may take into account the pixel dimensions of each map, the real-world dimensions represented by each map, and any existing transformation data associated with the parent map. For each matched feature point, the method can calculate its corresponding real-world coordinates in both the parent and child map coordinate systems. This step may involve applying scale factors, offset corrections, and coordinate system transformations specific to each map.

In step 512, the method can include transforming the child map based on the matched and converted feature points.

In some implementations, the method can calculate a homography matrix, which represents the perspective transformation between the two maps. The homography calculation may begin with an initial estimate using methods such as the Direct Linear Transform (DLT) algorithm. This initial estimate can then be refined using non-linear optimization techniques, such as the Levenberg-Marquardt algorithm, to minimize the reprojection error of the matched points. In some implementations, the resulting homography matrix is decomposed into its constituent components: rotation, translation, and scaling. The method can then apply this transformation to the child map, resulting in a transformed version that is aligned with the parent map.

After applying the transformation, the method can perform a final validation of the alignment. In some implementations, this includes calculating the residual error between the transformed child map features and their corresponding parent map features. The method may also compare the calculated transformation parameters against expected ranges to detect potential misalignments. Additionally, in some implementations, the method can apply image similarity metrics between the transformed child map and the overlapping region of the parent map to assess the quality of alignment.

If the validation passes predetermined thresholds, the automatic alignment can be considered successful. In some implementations, the resulting transformation matrix is then integrated into the a corresponding transformation tree. If the validation fails, the method can attempt the alignment process again with different parameters, or flag the alignment for manual review and adjustment as described in FIG. 3. This iterative approach can ensure that the method produces alignments, even in challenging scenarios with complex map features or significant differences between the parent and child maps.

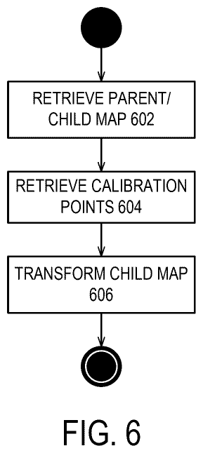

FIG. 6 is a flow diagram illustrating a method for manual map alignment using calibration points according to some of the example embodiments. This process may typically be employed when automatic alignment is not feasible or when greater precision is required due to the nature of the maps being aligned.

In step 602, the method can retrieve the parent and child maps.

In some implementations, the parent map serves as the reference to which the child map will be aligned. In some implementations, the method can access not only the visual representation of the maps but also any associated metadata, such as scale information, coordinate system details, and any pre-existing transformation data. This comprehensive retrieval may ensure that all relevant information is available for the manual alignment process.

In some implementations, the method may perform initial preprocessing on the retrieved maps to optimize them for display and interaction. This can include adjusting contrast and brightness for better visibility, applying image enhancements to highlight key features, and ensuring that both maps are rendered at appropriate resolutions for the user interface. The preprocessed maps may then be presented to the user through the map UI component, allowing for visualization and interaction during the manual alignment process.

In step 604, the method can include retrieving calibration points.

In some implementations, these points are user-defined correspondences between the parent and child maps. The method may provide an interface within the map UI for the user to select and mark these calibration points. In some implementations, the user can be prompted to identify at least three non-collinear points on each map that represent the same physical locations. In some implementations, the interface offers tools such as zoom and pan functionalities to assist the user in accurately placing these points.

As the user selects each calibration point, the method can record its coordinates in both pixel and real-world units. For pixel coordinates, the method may capture the x-and y-positions relative to the map image. For real-world coordinates, in some implementations, the method can use the map's scale and reference information to convert the pixel positions into meaningful spatial coordinates, such as meters or geographic coordinates.

In some implementations, the method can employ real-time validation checks as calibration points are being selected. These checks can include ensuring a minimum distance between points to avoid clustering, verifying that the points are not collinear, and providing visual feedback on the distribution of points across the maps. This real-time validation may help guide the user towards selecting a set of calibration points that will result in a robust and accurate transformation.

In step 606, the method can transform the child map based on the user-defined calibration points.

In some implementations, this transformation process includes mathematical operations to compute and apply the appropriate spatial transformation that aligns the child map with the parent map. The transformation calculation may begin by determining the type of transformation required based on the number and distribution of calibration points. In some implementations, with three points, the method can compute an affine transformation, which allows for translation, rotation, scaling, and shearing. With four or more points, a more complex perspective transformation can be calculated, which may account for more significant distortions between the maps.

To calculate the transformation matrix, the method can use techniques such as the least squares method to find the optimal transformation that minimizes the overall error across all calibration points. In some implementations, this involves setting up and solving a system of linear equations that relate the coordinates of the calibration points in the child map to their corresponding coordinates in the parent map.

Once the transformation matrix is computed, the method may apply it to the entire child map. This process can involve transforming every pixel of the child map according to the calculated matrix. For efficiency, in some implementations, the method can inverse mapping and/or interpolation processes to avoid gaps or artifacts in the transformed map.

After the initial transformation is applied, the method can perform a series of quality checks to assess the accuracy of the alignment. These checks may include calculating the residual error for each calibration point, computing the overall root mean square error (RMSE) of the transformation, and visually overlaying the transformed child map on the parent map to highlight any misalignments.

In some implementations, the results of these quality checks are presented to the user through the map UI. The interface may display metrics such as the RMSE, individual point errors, and a visual representation of the alignment accuracy. This feedback can allow the user to evaluate the quality of the manual alignment and make decisions about whether further adjustments are needed.

If the alignment quality does not meet the desired standards, in some implementations, the user can refine the calibration points. This can involve adjusting the positions of existing points, adding new points for increased accuracy, or removing points that may be introducing errors. The method may support an iterative process where the user can make these adjustments and immediately see the effects on the alignment quality.

Once the user is satisfied with the alignment, the method can finalize the transformation. In some implementations, the computed transformation matrix is stored in both pixel-based and real-world coordinate formats to support various use cases within the system. The transformation may then be integrated into a transformation tree described in FIG. 1 and FIG. 2, establishing the spatial relationship between the child and parent maps within the broader context of the system's map hierarchy.

The manual alignment process described in FIG. 6 can provide a method for aligning maps that may be challenging for automatic processes. By leveraging human expertise and visual interpretation, this method may achieve high-precision alignments even in cases with complex map features, significant distortions, or limited common reference points between maps.

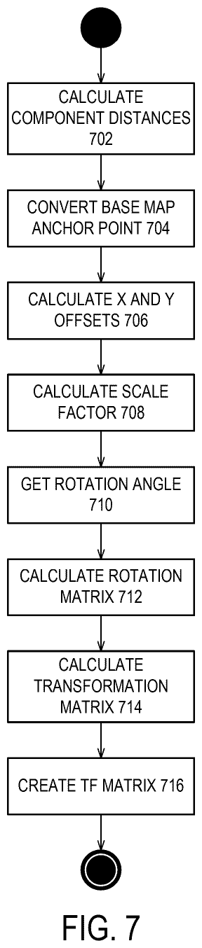

FIG. 7 is a flow diagram illustrating a method for manual alignment of geographic maps using warp factors according to some of the example embodiments.

In step 702, the method can include calculating component distances between the latitude/longitude origin point and the latitude/longitude anchor point of the geographic map.

In some implementations, this calculation utilizes the Haversine formula to account for the curvature of the Earth when computing distances on a spherical surface. The Haversine formula may provide accurate results for short distances compared to the simple Euclidean distance calculation. The method can compute both the total great-circle distance and its north-south and east-west components. These component distances may form the basis for relating the geographic coordinates to the local coordinate system of the base map.

In step 704, the method can include converting the base map anchor point from pixels to meters.

In some implementations, the base map, typically a non-geographic map such as a floor plan or site layout, uses a local coordinate system often measured in pixels. To align this with the geographic map, the method may first convert the pixel coordinates to real-world units. This conversion can rely on the pixel pitch information provided in the base map metadata. The pixel pitch may define the real-world distance represented by each pixel in the map. The method can apply this conversion factor to the x-and y-coordinates of the anchor point, resulting in a meter-based representation of the point's position within the base map's local coordinate system.

In step 706, the method can include calculating x and y offsets.

In some implementations, these offsets represent the displacement between the geographic map's origin and the base map's anchor point in the shared coordinate system. The method may subtract the converted base map anchor point coordinates from the component distances calculated in step 702. This operation can effectively determine how far and in which direction the base map needs to be shifted to align with the geographic coordinates. The resulting offsets may be used for ensuring that the two maps are correctly positioned relative to each other in the final alignment.

In step 708, the method can include calculating the scale factor between the geographic map and the base map.

In some implementations, this scale factor is useful for ensuring that distances and areas are consistently represented across both maps. The calculation may account for the different coordinate systems and units used by each map. For the geographic map, the method can consider the number of meters per degree of latitude and longitude at the given location, which may vary depending on the position on the Earth's surface. For the base map, it may use the previously established pixel-to-meter conversion factor. By comparing these two scaling factors, the method can compute a single scale factor that will be applied to transform coordinates between the two maps.

In step 710, the method can include retrieving the rotation angle of the base map.

In some implementations, this angle represents the orientation difference between the base map and true north as represented in the geographic map. The rotation angle may typically be provided by the user during the manual alignment process, where they visually align the base map with known geographic features or directions. The method can store this angle for use in the subsequent transformation calculations.

In step 712, the method can include calculating the rotation matrix.

In some implementations, using the rotation angle obtained in the previous step, the method constructs a 2D rotation matrix. This matrix may be used to adjust the orientation of coordinates transformed between the two maps. The rotation matrix can be computed using standard trigonometric functions, with the sine and cosine of the rotation angle as its components.

In step 714, the method can include calculating the transformation matrix.

In some implementations, this matrix combines the previously computed scale factor, rotation, and offsets into a single 3×3 homogeneous transformation matrix. The upper-left 2×2 submatrix may incorporate both the rotation and scaling, while the right column can include the x and y offsets. This comprehensive transformation matrix may encapsulate all the operations to convert coordinates from the base map's local system to the geographic coordinate system.

In step 716, the method can include creating the transformation matrix.

In some implementations, the method inverts the matrix calculated in the previous step to obtain the transformation from the geographic coordinate system to the base map's local system. Both the original and inverted matrices may be stored, allowing for efficient bidirectional coordinate conversions. The method can also compute and store additional metadata about the transformation, such as error estimates for the alignment, valid regions for the transformation, and any constraints or limitations of the alignment.

In some implementations, the resulting transformation matrix and its inverse are then integrated into the transformation tree structure, as described in FIG. 1 and FIG. 2. This integration may enable the newly aligned geographic map to be related to other maps in the method, supporting complex spatial queries and multi-map coordinate transformations. The manual alignment process for geographic maps, as outlined in FIG. 7, can provide a method for integrating diverse map types into a unified spatial framework. By considering the mathematical relationships between different coordinate systems and incorporating user-provided alignment information, the method may achieve accurate and flexible geographic referencing for a wide range of map types and use cases.

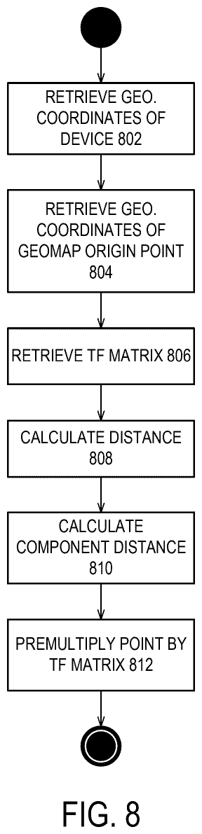

FIG. 8 is a flow diagram illustrating a method for transforming GPS coordinates to a Cartesian coordinate system according to some of the example embodiments.

In step 802, the method can include retrieving the geographic coordinates of the device.

In some implementations, these coordinates are typically provided as latitude and longitude values, often obtained from a GPS receiver or similar positioning system. The method may perform initial validation on these coordinates to ensure they fall within expected ranges and conform to the standard format used within the system. This step can also involve converting the coordinates to a standardized representation if they are received in a different format, such as degrees-minutes-seconds or decimal degrees.

In step 804, the method can include retrieving the geographic coordinates of the geomap origin point.

In some implementations, the geomap origin serves as the reference point for the local Cartesian coordinate system. This origin point may typically be defined during the map alignment process and stored as part of the map metadata. The method can access this information from its internal data structures, ensuring that the most up-to-date reference point is used for the transformation. The origin point may be used as it establishes the zero point of the local coordinate system and influences all subsequent calculations.

In step 806, the method can include retrieving the transformation matrix for converting between the geographic coordinate system and the local Cartesian system.

In some implementations, this matrix, previously computed and stored during the map alignment process described in FIG. 7, encapsulates the scale, rotation, and translation parameters for coordinate conversion. The method may access this matrix from the transformation tree structure, traversing the tree if necessary to find the appropriate transformation for the current map context.

In step 808, the method can include calculating the distance between the device's location and the geomap origin point.

In some implementations, this calculation utilizes the Haversine formula to account for the Earth's curvature. The Haversine formula may provide an accurate measurement of great-circle distances on a sphere compared to simpler Euclidean distance calculations. The method can compute this distance in meters, taking into account the Earth's radius and the specific latitude of the points involved, as the length of a degree of longitude varies with latitude.

In step 810, the method can calculate the component distances in the x and y directions.

In some implementations, these components represent the north-south and east-west displacements of the device relative to the geomap origin. The method may use the previously calculated total distance along with the relative positions of the two points to determine these component distances. This step can effectively project the curved surface of the Earth onto a flat plane tangent to the geomap origin, providing a local approximation of the device's position in a Cartesian system.

In step 812, the method can include premultiplying a point by the transformation matrix.

In some implementations, the method takes the component distances calculated in the previous step and applies the transformation matrix retrieved in step 806. This operation may involve matrix multiplication, where the component distances are treated as a vector and multiplied by the transformation matrix. The resulting vector can represent the device's position in the local Cartesian coordinate system of the map.

After the matrix multiplication, the method may perform additional post-processing on the transformed coordinates. This can include rounding the values to an appropriate level of precision, checking that the transformed point falls within the valid bounds of the local map, and applying any offset corrections specific to the target coordinate system.

The final output of this process is a pair of x and y coordinates representing the device's position in the local Cartesian system. These coordinates can be directly used for various purposes such as displaying the device's location on a map, performing spatial analysis, or integrating with other location-based services that operate in the local coordinate system.

The method may also compute and store additional metadata about the transformation, such as the estimated accuracy of the converted position. This accuracy estimate can take into account factors like the precision of the original GPS coordinates, the accuracy of the map alignment, and any known distortions or limitations of the local coordinate system.

In cases where the transformation needs to be applied to multiple points or a stream of real-time location data, the method may optimize the method by caching intermediate calculation results or using incremental update techniques to reduce computational overhead.

The method described in FIG. 8 bridges the gap between global positioning systems and local mapping applications. By providing a reliable method for transforming GPS coordinates into a local Cartesian system, it enables integration of real-world location data with custom maps and spatial databases. This capability is fundamental to a wide range of applications, from indoor navigation and asset tracking to geographic information systems and location-based services.

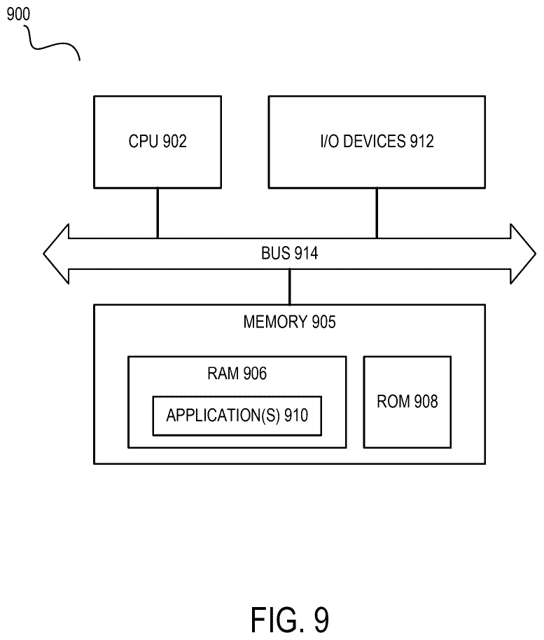

FIG. 9 is a block diagram of a computing device according to some embodiments of the disclosure.

As illustrated, the device 900 includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose CPU. The CPU 902 may comprise a single-core or multiple-core CPU. The CPU 902 may comprise a system-on-a-chip (SoC) or a similar embedded system. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the method or of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a computing device, a map;
selecting, by the computing device, an alignment map for aligning the map;
selecting, by the computing device, an alignment method;
performing, by the computing device and based on the alignment method, an alignment process to generate a transformation matrix that defines a spatial
relationship between the map and the alignment map; and
updating, by the computing device, a transformation tree data structure with the transformation matrix.

2. The method of claim 1, wherein the alignment process comprises:
retrieving the map and the alignment map;
converting the map and the alignment map to a common format;
preparing a template for feature detection;
detecting alignment points via feature matching;
converting the alignment points to converted points; and
transforming the map using the alignment points and converted points.

3. The method of claim 1, wherein the alignment process comprises:
retrieving the map and the alignment map;
retrieving calibration points defined by a user; and
transforming the map based on the calibration points.

4. The method of claim 1, wherein performing the alignment process comprises:
receiving a geocode;
selecting an alignment map;
selecting an anchor point;
performing rotation and scaling operations; and
defining the transformation matrix.

5. The method of claim 1, wherein creating the transformation matrix comprises:
calculating component distances between a latitude/longitude origin point and a latitude/longitude anchor point;
converting a base map anchor point from pixels to meters;
calculating x and y offsets;
calculating a scale factor between the map and the alignment map;
computing a rotation angle; and
calculating a rotation matrix.

6. The method of claim 1, further comprising:
retrieving, by the computing device, geographic coordinates of a device;
retrieving, by the computing device, geographic coordinates of a geomap origin point of a geomap;
retrieving, by the computing device, a transformation matrix for the geomap;
calculating, by the computing device, a distance between the geographic coordinates of the device and the geomap origin point;
calculating, by the computing device, component distances; and
multiplying, by the computing device, the component distances by the transformation matrix to obtain transformed coordinates.

7. The method of claim 1, wherein updating the transformation tree data structure comprises creating a node for the map and connecting it to a node representing the alignment map using an edge that represents the transformation matrix.

8. A non-transitory computer-readable storage medium for tangibly storing computer program instructions capable of being executed by a computer processor, the computer program instructions defining steps of:
receiving a map;
selecting an alignment map for aligning the map;
selecting an alignment method;
performing, based on the alignment method, an alignment process to generate a transformation matrix that defines a spatial relationship between the map and the alignment map; and
updating a transformation tree data structure with the transformation matrix.

9. The non-transitory computer-readable storage medium of claim 8, wherein the alignment process comprises:
retrieving the map and the alignment map;
converting the map and the alignment map to a common format;
preparing a template for feature detection;
detecting alignment points via feature matching;
converting the alignment points to converted points; and
transforming the map using the alignment points and converted points.

10. The non-transitory computer-readable storage medium of claim 8, wherein the alignment process comprises:
retrieving the map and the alignment map;
retrieving calibration points defined by a user; and
transforming the map based on the calibration points.

11. The non-transitory computer-readable storage medium of claim 8, wherein performing the alignment process comprises:
receiving a geocode;
selecting an alignment map;
selecting an anchor point;
performing rotation and scaling operations; and
defining the transformation matrix.

12. The non-transitory computer-readable storage medium of claim 8, wherein creating the transformation matrix comprises:
calculating component distances between a latitude/longitude origin point and a latitude/longitude anchor point;
converting a base map anchor point from pixels to meters;
calculating x and y offsets;
calculating a scale factor between the map and the alignment map;
computing a rotation angle; and
calculating a rotation matrix.

13. The non-transitory computer-readable storage medium of claim 8, the steps further comprising:
retrieving geographic coordinates of a device;
retrieving geographic coordinates of a geomap origin point of a geomap;
retrieving a transformation matrix for the geomap;
calculating a distance between the geographic coordinates of the device and the geomap origin point;
calculating component distances; and
multiplying the component distances by the transformation matrix to obtain transformed coordinates.

14. The non-transitory computer-readable storage medium of claim 8, wherein updating the transformation tree data structure comprises creating a node for the map and connecting it to a node representing the alignment map using an edge that represents the transformation matrix.

15. A device comprising:
a memory; and
a processor configured for:
receiving a map;
selecting an alignment map for aligning the map;
selecting an alignment method;
performing, based on the alignment method, an alignment process to generate a transformation matrix that defines a spatial relationship between the map and the alignment map; and
updating a transformation tree data structure with the transformation matrix.

16. The device of claim 15, wherein the alignment process comprises:
retrieving the map and the alignment map;
converting the map and the alignment map to a common format;
preparing a template for feature detection;
detecting alignment points via feature matching;
converting the alignment points to converted points; and
transforming the map using the alignment points and converted points.

17. The device of claim 15, wherein the alignment process comprises:
retrieving the map and the alignment map;
retrieving calibration points defined by a user; and
transforming the map based on the calibration points.

18. The device of claim 15, wherein performing the alignment process comprises:
receiving a geocode;
selecting an alignment map;
selecting an anchor point;
performing rotation and scaling operations; and
defining the transformation matrix.

19. The device of claim 15, wherein creating the transformation matrix comprises:
calculating component distances between a latitude/longitude origin point and a latitude/longitude anchor point;
converting a base map anchor point from pixels to meters;
calculating x and y offsets;
calculating a scale factor between the map and the alignment map;
computing a rotation angle; and
calculating a rotation matrix.

20. The device of claim 15, the processor further configured for:
retrieving geographic coordinates of a device;
retrieving geographic coordinates of a geomap origin point of a geomap;
retrieving a transformation matrix for the geomap;
calculating a distance between the geographic coordinates of the device and the geomap origin point;
calculating component distances; and
multiplying the component distances by the transformation matrix to obtain transformed coordinates.
